(19) United States
(12) Patent Application Publication
(10) Pub. No.: US 2018/0336243 A1
(43) Pub. Date: Nov. 22, 2018

(54) Image Search Method, Apparatus and Storage Medium

(71) Applicant: Baidu Online Network Technology (Beijing) Co., Ltd, Beijing (CN)

(72) Inventor: Tong Yan, Beijing (CN)

(73) Assignee: Baidu Online Network Technology (Beijing) Co., Ltd ., Beijing (CN)

(21) Appl. No.: 15/504,201

(22) PCT Filed: Oct. 21, 2015
(86) PCT No.: PCT/CN2015/092418

§ 371 Date: Feb. 15, 2017

(30) Foreign Application Priority Data
May 21, 2015 (CN) 201510262908.4

(51) Int. Cl. G06F 17/30

(52) U.S. Cl. CPC G06F 17/30407

(57) ABSTRACT

The embodiments of the present application disclose an image search method, apparatus and storage medium. The image search method comprises: displaying an image; identifying, based on a sliding trace caused by a user on the image, a selected region; determining, based on the selected region, a search target in the image; transmitting, based on the search instruction entered by the user, a search request based on the search target. The image search method and apparatus according to the embodiments of the present disclosure may easily identify the pictorial image corresponding to the to-be searched object from the search image.

### CROSS REFERENCE TO RELATED APPLICATION

This application claims the priority of Chinese Patent Application No. 201510262908.4, entitled “Image Search Method and Apparatus” filed by Baidu Online Network Technology (Beijing) Co., Ltd., on May 21, 2015, the content of which is incorporated herein by reference in its entirety.

### TECHNICAL FIELD

The embodiments of the present disclosure relate to the field of search engine technology, specifically to an image search method, apparatus and storage medium.

### BACKGROUND

With the prevailing of Internet today, search engines have become an indispensable tool in our ordinary life. Image search technology begins to appear as the search engine technology matures by the day. As compared with the relatively mature text search that has been researched and practiced for years, image search lags behind in both theoretical research and engineering implementation. On the basis of the existing technologies for implementing an image search engine, image search engines may be classified into image search engines based on text, image search engines based on content, and image search engines based on semantics.

The content-based image search technology uses the visual characteristics of the image, e.g., color, texture, shape, as the representative characteristics of the image to seek and match, and to obtain subsequently search results the user may need. The existing content-based image search engine generally requires the background of the to-be-searched image provided by the user to be as simple as possible, to facilitate the identification of the object the user desires to search in the image. However, in practice, the search image provided by the user does not necessarily meet such a requirement. For example, when a user needs to search a building she passes by, and the building is located between many buildings, it will be difficult to find a shooting angle to only photograph the building to be searched. In this situation, it will be difficult to obtain an image of the building with simple background. For the above-mentioned reason, the extent to apply the image search is very limited, causing lower popularity.

### SUMMARY

The embodiments of the present disclosure provide an image search method, apparatus and storage medium for easily identifying a pictorial image corresponding to the to-be-searched object in the search image.

In a first aspect, the embodiments of the present disclosure provide an image search method, comprising:

displaying an image;

identifying, based on a sliding trace caused by a user on the image, a selected region;

determining, based on the selected region, a search target in the image; and

transmitting, based on search instruction entered by the user, a search request based on the search target.

In a second aspect, the embodiments of the present disclosure further provide an image search apparatus, comprising:

a display module configured to display an image;

an identification module configured to identify a selected region based on a sliding trace caused by a user on the image;

a target determination module configured to determine a search target in the image based on the selected region; and

a request module configured to transmit, based on a search instruction entered by the user, a search request based on the search target.

In a third aspect, the embodiments of the present disclosure provide a storage medium containing computer executable instructions, the computer executable instructions being configured to execute an image search method when executed by a computer processor, the method comprising:

displaying an image;

identifying, based on the sliding trace caused by a user on the image, a selected region;

determining, based on the selected region, a search target in the image; and

transmitting, based on the search instruction entered by the user, a search request based on the search target.

In accordance with the image search method, apparatus and storage medium according to the embodiments of the present disclosure, a pictorial image corresponding to a to-be-searched object can be easily identified from the search image by: displaying an image, identifying, based on a sliding trace caused by a user on the image, a selected region, determining, based on the selected region, a search target in the image, and transmitting, based on the search instruction entered by the user, a search request based on the search target.

### BRIEF DESCRIPTION OF THE DRAWINGS

To describe the technical solutions in the embodiments of the present disclosure more clearly, the accompanying drawings required for describing the embodiments will be briefly described as follows. Naturally, the accompanying drawings in the following description show merely some embodiments of the present disclosure, and those skilled in the art may make modifications and substitutions to these drawings without inventive efforts.

FIG. 1 is a flowchart of an image search method according to a first embodiment of the present disclosure;

FIG. 2 is a flowchart of an image search method according to a second embodiment of the present disclosure;

FIG. 3A is a diagram of an image display interface before the image is distinctively-displayed and label-displayed according to the second embodiment of the present disclosure;

FIG. 3B is a diagram of an image display interface after the image is distinctively-displayed and label-displayed according to the second embodiment of the present disclosure;

FIG. 4 is a flowchart of identification in an image search method according to a third embodiment of the present disclosure;

FIG. 5 is a flowchart of determining a target in the image search method according to a fourth embodiment of the present disclosure; and

FIG. 6 is a structural diagram of the image search apparatus according to a fifth embodiment of the present disclosure.

### DETAILED DESCRIPTION OF EMBODIMENTS

The technical solutions in the embodiments of the present disclosure will be clearly and completely described below in combination with the accompanying drawings. Evidently, the described embodiments are part of the embodiments of the present disclosure rather than all of the embodiments. The embodiments described are used for explaining the principles of the present disclosure, rather than limiting the present disclosure to these specific embodiments. All of the other embodiments obtained by those skilled in the art, based on the embodiments of the present disclosure and without inventive efforts, fall into the protection scope of the present disclosure.

### First Embodiment

The present embodiment provides a technical solution to an image search method. The technical solution may be executed by an image search apparatus, which may be integrated into a computing device on the user's side, e.g., a smart mobile terminal, or a PC machine.

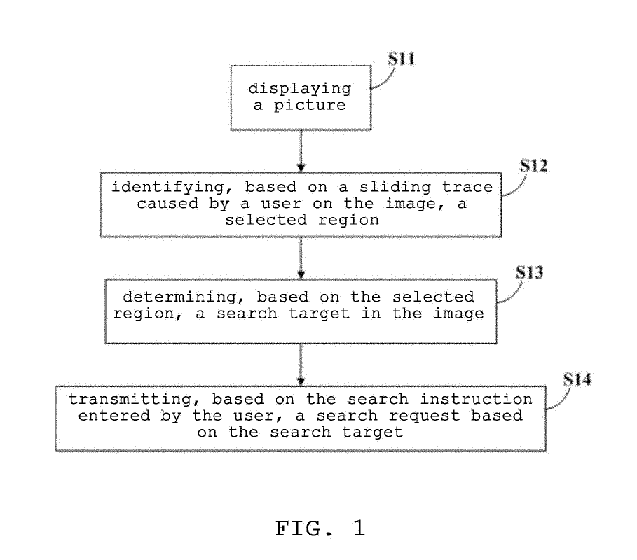

Specifically, with reference to FIG. 1, the image search method comprises:

S11, displaying an image.

The image for acquiring the search target shall be acquired and displayed before image search is initiated using the search target in the image. The image may be one photographed by a user with a camera or one downloaded by a user from a network.

S12, identifying, based on a sliding trace caused by a user on the image, a selected region.

In order to identify the search target from the image more easily, a user is allowed to define a selected region that can indicate the display scope of the search target by a sliding operation on the display screen. The selected region is identified based on a sliding trace caused by a user on the image after the user has conducted the sliding operation via a touch-control display screen.

Specifically, the region on the display screen touched by the finger during the sliding operation performed by the user may be detected. The region touched by the user's finger during the sliding operation is the region covered by the sliding trace. Then, the region touched by the finger during the sliding operation may be identified as the selected region. As a result, identifying the selected region is achieved by identifying the sliding trace.

S13, determining, based on the selected region, a search target in the image.

The search target is determined in the selected region after the selected region is identified. Specifically, the search target may be automatically determined in the selected region according to the specific target identification algorithm, the search target may also be semi-automatically determined in the selected region based on further instruction indications from the user.

S14, transmitting, based on the search instruction entered by the user, a search request based on the search target.

Once the search target is determined, a search request may be transmitted to an image search server based on the determined search target. Specifically, the search request is transmitted based on the search instruction entered by the user.

Further, the search target may be distinctively-displayed on the touch-control display screen after the search target is determined, and a search control for transmitting the search request is displayed on the periphery of the distinctively-displayed search target, and the search request is transmitted based on the user's operation on the search control.

According to the embodiment, the pictorial image corresponding to the to-be searched object may be easily identified from the search image by displaying an image, identifying, based on a sliding trace caused by a user on the image, a selected region; determining, based on the selected region, a search target in the image; and transmitting, based on the search instruction entered by the user, a search request based on the search target.

### Second Embodiment

The present embodiment, on the basis of the above-mentioned embodiment of the present disclosure, further provides a technical solution to the image search method. In the technical solution, after determining the search target in the image based on the selected region, the method further comprises:

displaying the search target distinctively in the image; and establishing a search label for the search target and displaying the search target, the search label being used by the user to enter the search instruction.

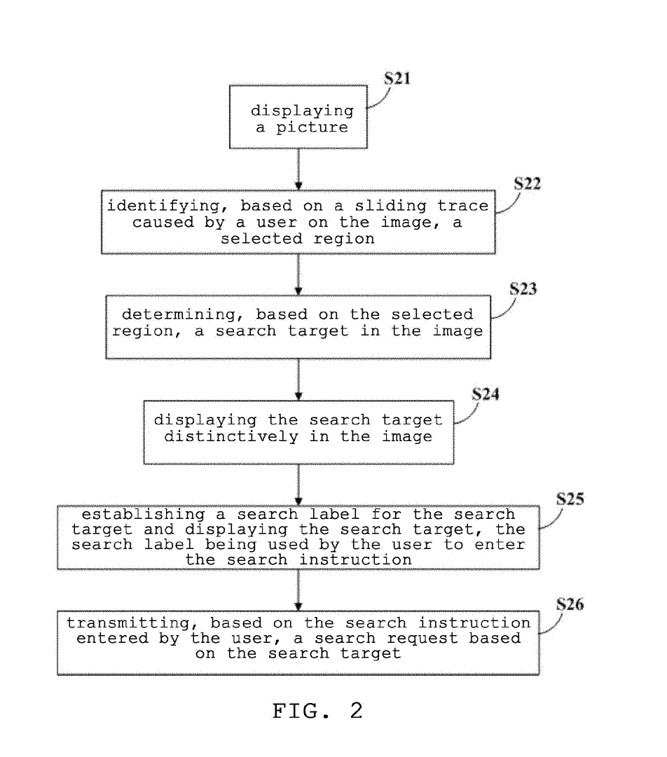

Specifically, with reference to FIG. 2, the image search method comprises:

S21, displaying an image;

S22, identifying, based on a sliding trace caused by a user on the image, a selected region;

S23, determining, based on the selected region, a search target in the image; and

S24, displaying the search target distinctively in the image.

The search target is distinctively-displayed in the image after the search target is determined in the selected region. Displaying distinctively means displaying the pictorial image region corresponding to the search target in a display fashion different from the fashion in which the other pictorial image regions are displayed. Preferably, a translucent mask may be formed above the pictorial image region corresponding to the search target, and displayed.

S25, establishing a search label for the search target and displaying the search target, the search label being used by the user to enter the search instruction.

Apart from displaying the search target distinctively, a search label may also be displayed. The label may be a display control used by the user to enter instructions so as to transmit a search request. Specifically, the search label may be a button or other display controls.

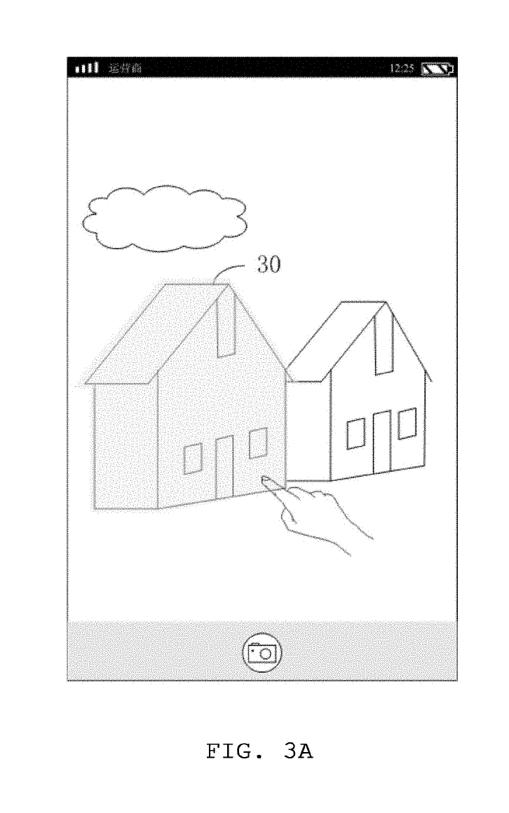

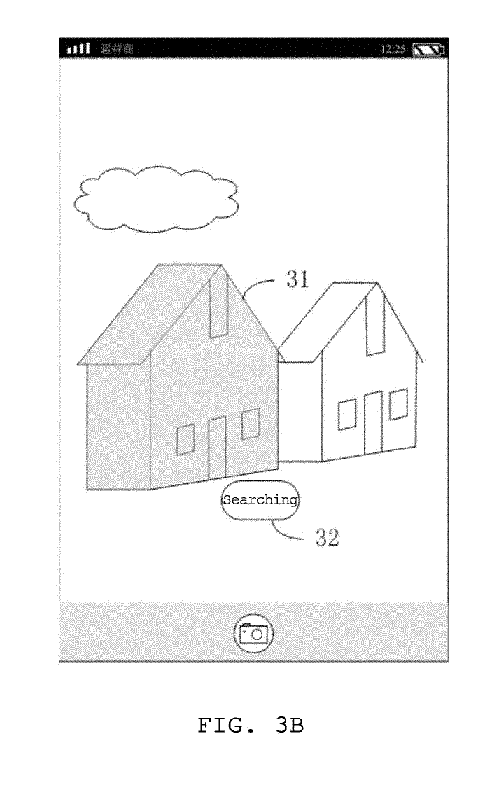

FIGS. 3A and 3B are respective diagrams of the image display interface before and after the image is distinctively-displayed and label-displayed. Referring to FIGS. 3A and 3B, the search target 31 is distinctively-displayed after the search target 31 is determined based on the region 30 covered by a sliding trace caused by a user. And a search label 32 used by the user to enter a search instruction is displayed on the periphery of the search target.

S26, transmitting, based on the search instruction entered by the user, a search request based on the search target.

The embodiment facilitates the user's entering the search instruction based on the search target, before transmitting the search request by, displaying the search target distinctively in the image and establishing a search label for the search target and displaying the search target, the search label being used by the user to enter the search instruction after determining the search target in the image based on the selected region.

### Third Embodiment

The present embodiment, on the basis of the above-mentioned embodiments of the present disclosure, further provides a technical solution to the identifying operation of the image search method. In the technical solution, the identifying the selected region based on a sliding trace caused by a user on the image comprises: calculating an area of the region covered by the sliding trace; defining the region as the selected region, if the area of the region is larger than a pre-set area threshold; and transmitting exception information to the user, if the area of the region is smaller than or equal to the pre-set area threshold.

Specifically, with reference to FIG. 4, the identifying the selected region based on a sliding trace caused by a user on the image comprises:

S41, calculating an area of the region covered by the sliding trace.

If the area of the region covered by the sliding trace caused by a user is too small, it will be difficult to define a selected region from the region covered by the sliding trace. Therefore, the region covered by the sliding trace needs to be further filtered by calculating the area of the region. When the region filtering is conducted, the area of the region covered by the sliding trace is first calculated.

S42, defining the region as the selected region, if the area of the region is larger than a pre-set area threshold.

In relation to the area of the region covered by the sliding trace, there is a pre-set area threshold. The area threshold is a low-limit threshold. In other words, the region covered by the sliding trace can be defined as the selected region only in the situation where the area of the region covered by the sliding trace is larger than the area threshold.

S43, transmitting exception information to the user, if the area of the region is smaller than or equal to the pre-set area threshold.

Exception information needs to be transmitted to the user if the area of the region covered by the sliding trace is not larger than the area threshold, that is, the area of the region is smaller than or equal to the area threshold.

The present embodiment effectively avoids the situation where it is difficult to define the selected region if the area of the region covered by the sliding trace is too small, and increases the error tolerance of the image search method by calculating an area of the region covered by the sliding trace; defining the region as the selected region, if the area of the region is larger than a pre-set area threshold; and transmitting exception information to the user, if the area of the region is smaller than or equal to the pre-set area threshold.

### Fourth Embodiment

The present embodiment, on the basis of the above-mentioned embodiments of the present disclosure, further provides a technical solution to the operation of determining the target in the image search method. In this technical solution, the determining, based on the selected region, a search target in the image comprises: acquiring at least one pixel in the selected image in the selected region; and identifying a principal containing the at least one pixel in the image as the search target.

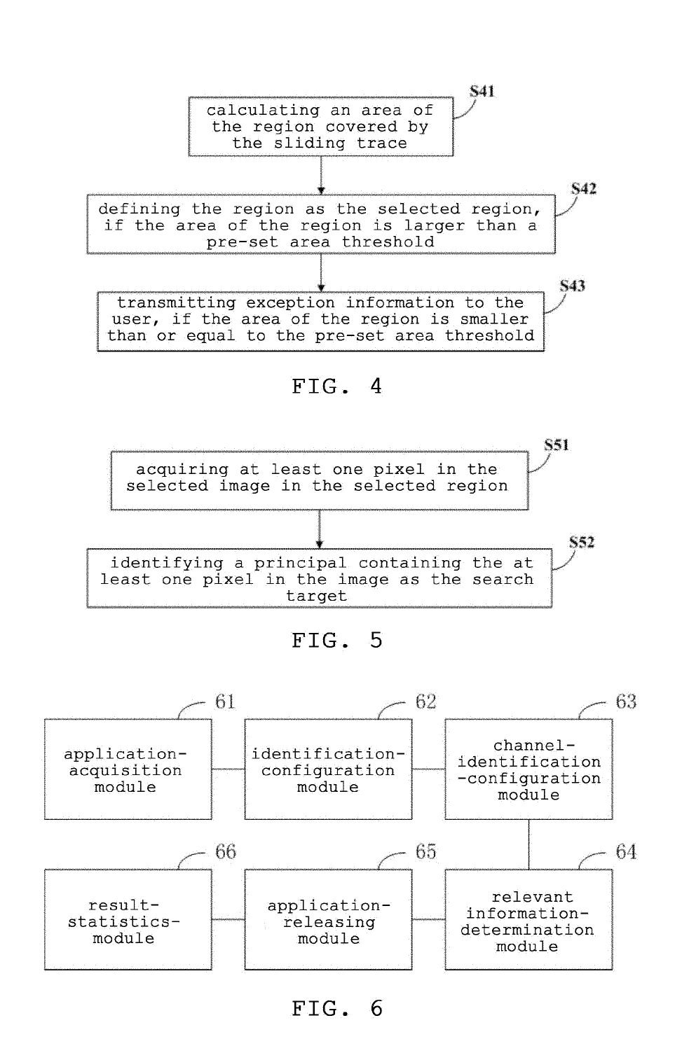

Specifically, with reference to FIG. 5, the determining, based on the selected region, a search target in the image comprises:

S51, acquiring at least one pixel in the selected image in the selected region.

It should be understood that although the selected region is defined in the image by the sliding operation, the selected region may still include pictorial images of objects that do not belong to a search target. To further easily identify the search target from the selected region, the user may further select the at least one pixel which belongs to the search target in the selected region after the selected region on the image is defined.

S52, identifying a principal containing the at least one pixel in the image as the search target.

After the at least one pixel is acquired, a principal containing one pixel or these pixels is identified from the image, and the principal acquired by identification is the search target.

The embodiment makes it easier to identify the search target by acquiring at least one pixel in the selected image in the selected region, and identifying a principal containing the at least one pixel in the image as the search target.

### Fifth Embodiment

The present embodiment provides a technical solution to an image search apparatus. In the technical solution, the image search apparatus comprises: a display module 61, an identification module 62, a target determination module 63 and a request module 66.

The display module 61 is configured to display an image.

The identification module 62 is configured to identify a selected region based on a sliding trace caused by a user.

The target determination module 63 is configured to determine a search target in the image based on the selected region.

The request module 66 is configured to transmit, based on a search instruction entered by the user, a search request based on the search target.

Further, the image search apparatus further comprises: a distinction display module 64 and a label display module 65.

The distinction display module 64 is configured to display the search target distinctively in the image after determining the search target in the image based on the selected region.

The label display module 65 is configured to establish a search label for the search target and display the search target, the search label being used by the user to enter the search instruction.

Further, the identification module 62 comprises:

a computing sub-module configured to calculate the area of the region covered by the sliding trace;

a region determination sub-module configured to define the region as the selected region if the area of the region is larger than a pre-set area threshold; and

an exception sub-module configured to transmit exception information to the user if the area of the region is smaller than or equal to a pre-set area threshold.

Further, the target determination module 63 comprises:

a pixel determination sub-module configured to acquire the at least one pixel in the image selected in the selected region; and

a principal identification sub-module configured to identify a principal containing the pixel in the image as the search target.

The above-mentioned image search apparatus may implement the image search methods according to any of the embodiments of the present disclosure, and have the functional modules and advantageous effect corresponding to the implementations of the method.

Those skilled in the art should understand that each of the above-mentioned modules or steps of the present disclosure may be implemented by a general computing device and may be collectively implemented on a single computing device or distributed on a network formed by several computing devices. Alternatively, they may be implemented by program codes executable by a computer device so that they may be stored in a storage device to be executed by a computing device, or they may be respectively made into individual integrated circuit module, or many modules or steps thereof may be made into single integrated circuit module to be implemented. Accordingly, the present disclosure is not limited to any particular combination of hardware with software.

### Sixth Embodiment

A storage medium containing computer executable instructions, the computer executable instructions being configured to execute an image search method when executed by a computer processor, the method comprising:

displaying an image;

identifying, based on the sliding trace caused by a user on the image, a selected region;

determining, based on the selected region, a search target in the image; and

transmitting, based on the search instruction entered by the user, a search request based on the search target.

When the method is implemented by the above-mentioned storage medium, after determining the search target in the image based on the selected region, the method further comprises:

displaying the search target distinctively in the image; and

establishing a search label for the search target and displaying the search target, the search label being used by the user to enter the search instruction.

When the method is implemented by the above-mentioned storage medium, the identifying the selected region based on the sliding trace caused by a user on the image comprises:

calculating an area of the region covered by the sliding trace;

defining the region as the selected region, if the area of the region is larger than a pre-set area threshold; and

transmitting exception information to the user, if the area of the region is smaller than or equal to the pre-set area threshold.

When the method is implemented by the above-mentioned storage medium, the determining, based on the selected region, a search target in the image comprises:

acquiring at least one pixel in the selected image in the selected region; and

identifying a principal containing the at least one pixel in the image as the search target.

Those skilled in art may readily appreciate, through the foregoing description of the implementations, that the present disclosure may be implemented by software and necessary hardware. Naturally, the present disclosure may be implemented by hardware. However, the former is a better implementation in many cases. Based on such understanding, the technical solution of the present disclosure, or the portion that contributes to the prior art may be substantively represented in the form of software products. The computer software products may be stored in computer readable storage medium, for example, a disk, an optical disk, a read-only memory (ROM) or a random access memory (RAM), and include instructions for causing a computer device (which may be a personal computer, a server, or a network device, etc.) to execute the methods described in each embodiment of the present disclosure.

It should be noted that in the embodiments of the above-mentioned image search apparatus, the included modules and sub-modules are delineated based on the functional logic, but not limited to the above-mentioned delineation as long as the corresponding functions can be achieved. Furthermore, the specific name of each functional unit is merely for facilitating distinguishing the functional units from one another, and does not intend to limit the protection scope of the present disclosure.

Each of the implementations in the description are described in a progressive fashion, each of the implementations are focused on its differences from other implementations, and the same or similar portions of each implementation can refer to one another.

The foregoing is merely specific implementations of the present disclosure, but the protection scope of the present disclosure is not limited thereto. Any variations or substitutions readily conceivable to those skilled in the art within the disclosed technical scope of the present disclosure shall fall into the protection scope of the present disclosure. Accordingly, the protection scope of the present disclosure is determined by the protection scope of the claims.

1. An image search method, comprising:
displaying an image;
identifying, based on a sliding trace caused by a user on the image, a selected region;
determining, based on the selected region, a search target in the image; and
transmitting, based on the search instruction entered by the user, a search request based on the search target.

2. The method according to claim 1, after determining the search target in the image based on the selected region, the method further comprising:
displaying the search target distinctively in the image; and
establishing a search label for the search target and displaying the search target, the search label being used by the user to enter the search instruction.

3. The method according to claim 1, wherein the identifying the selected region based on the sliding trace caused by a user on the image comprises:
calculating an area of the region covered by the sliding trace;
defining the region as the selected region, if the area of the region is larger than a pre-set area threshold; and
transmitting exception information to the user, if the area of the region is smaller than or equal to the pre-set area threshold.

4. The method according to claim 1, wherein the determining, based on the selected region, a search target in the image comprises:
acquiring at least one pixel in the selected image in the selected region; and
identifying a principal containing the at least one pixel in the image as the search target.

5. An image search apparatus, comprising:
at least one processor; and
a memory storing instructions, which when executed by the at least one processor, cause the at least one processor to perform operations, the operations comprising:
displaying an image;
identifying a selected region based on a sliding trace caused by a user on the image;
determining a search target in the image based on the selected region; and
transmitting, based on a search instruction entered by the user, a search request based on the search target.

6. The apparatus according to claim 5, the operations further comprising:
displaying the search target distinctively in the image after the search target is determined in the image based on the selected region; and
establishing a search label for the search target and display the search target, the search label being used by the user to enter the search instruction.

7. The apparatus according to claim 5, wherein the identifying the selected region based on the sliding trace caused by a user on the image comprises:
calculating the area of the region covered by the sliding trace;
defining the region as the selected region if the area of the region is larger than a pre-set area threshold; and
transmitting exception information to the user if the area of the region is smaller than or equal to a pre-set area threshold.

8. The apparatus according to claim 5, wherein the target determination module comprises:
acquiring the at least one pixel in the image selected in the selected region; and
identifying a principal containing the pixel in the image as the search target.

9. A storage medium containing computer executable instructions, the computer executable instructions being configured to execute an image search method when executed by a computer processor, the method comprising:
displaying an image;
identifying, based on the sliding trace caused by a user on the image, a selected region;
determining, based on the selected region, a search target in the image; and
transmitting, based on the search instruction entered by the user, a search request based on the search target.
